(19) United States
(12) Patent Application Publication
(10) Pub. No.: US 2026/0095041 A1
(43) Pub. Date: Apr. 2, 2026

(54) SEMICONDUCTOR DEVICE

(71) Applicants: Atsushi WATANABE, Tokyo (JP); Junji TAKESHITA, Tokyo (JP)

(72) Inventors: Atsushi WATANABE, Tokyo (JP); Junji TAKESHITA, Tokyo (JP)

(73) Assignee: MITSUMI ELECTRIC CO., LTD., Tokyo (JP)

(21) Appl. No.: 19/334,197

(22) Filed: Sep. 19, 2025

(30) Foreign Application Priority Data
Oct. 1, 2024 (JP) 2024-172769
Aug. 7, 2025 (JP) 2025-132238

(51) Int. Cl. H02H 9/04; H02H 7/18; H02H 9/00

(52) U.S. Cl. CPC H02H 9/042; H02H 7/18; H02H 9/005

(57) ABSTRACT

A semiconductor device includes first and second external terminals connectable to positive and negative electrodes of a secondary battery; a third external terminal electrically connected to the first external terminal and configured to output a voltage received from the secondary battery to an outside; a fourth external terminal configured to receive a signal from the outside or output a signal to the outside; and a first integrated circuit and a second integrated circuit. The first integrated circuit includes a first power supply terminal; a first voltage terminal; a second power supply terminal; a first signal terminal; a second signal terminal; and a first diode. The second integrated circuit includes a third power supply terminal; a fourth power supply terminal; and a third signal terminal. The second integrated circuit controls charging and discharging of the secondary battery.

### CROSS-REFERENCE TO RELATED APPLICATIONS

This patent application is based on and claims priority to Japanese Patent Application No. 2024-172769 filed on Oct. 1, 2024, and Japanese Patent Application No. 2025-132238 filed on Aug. 7, 2025, the entire contents of which are incorporated herein by reference.

### TECHNICAL FIELD

The present disclosure relates to a semiconductor device.

### BACKGROUND

In an integrated circuit, a technique for protecting the integrated circuit from electro-static discharge (ESD) for an input/output terminal by arranging respective diodes between the input/output terminal and a ground line and between the input/output terminal and a power supply line is known (for example, see Patent Document 1).

Additionally, an ESD protection circuit is known, which not only protects a lone integrated circuit from ESD, but also protects an integrated circuit from ESD generated during an operation of a system on which the integrated circuit is mounted. This type of ESD protection circuit includes a voltage detection circuit having a low-pass filter structure and a discharging transistor configured to operate according to a result of the detection by the voltage detection circuit. The ESD protection circuit turns on the discharging transistor only when ESD occurs, and maintains the discharging transistor in an OFF state when noise occurs due to the system operation (for example, see Patent Document 2).

### RELATED ART DOCUMENT

### Patent Document

[Patent Document 1] Japanese Laid-open Patent Application Publication No. 2003-517215
[Patent Document 2] Japanese Laid-open Patent Application Publication No. 2020-155586

### SUMMARY

A semiconductor device includes a first external terminal connectable to a positive electrode of a secondary battery; a second external terminal connectable to a negative electrode of the secondary battery; a third external terminal electrically connected to the first external terminal and configured to output a voltage received from the secondary battery to an outside; a fourth external terminal configured to receive a signal from the outside or output a signal to the outside; a first integrated circuit; and a second integrated circuit. The first integrated circuit includes a first power supply terminal; a first voltage terminal connected to the third external terminal; a second power supply terminal connected to the second external terminal; a first signal terminal connected to the fourth external terminal and configured to receive or output a signal; a second signal terminal electrically connected to the first signal terminal; and a first diode having an anode electrically connected to the first signal terminal and a cathode electrically connected to the first voltage terminal. The second integrated circuit includes a third power supply terminal electrically connected to the first external terminal; a fourth power supply terminal configured to output, to the first power supply terminal, a power supply voltage generated based on a voltage received at the third power supply terminal; and a third signal terminal configured to receive a signal from the second signal terminal or output a signal to the second signal terminal. The second integrated circuit controls charging and discharging of the secondary battery.

### BRIEF DESCRIPTION OF THE DRAWINGS

FIG. 1 is a block diagram illustrating an embodiment of a semiconductor device according to the present disclosure;

FIG. 2 is a block diagram illustrating an example of another semiconductor device;

FIG. 3 is a block diagram illustrating a modified example of the semiconductor device of FIG. 1; and

FIG. 4 is a block diagram illustrating a modified example of the semiconductor device of FIG. 2.

### DETAILED DESCRIPTION

In a semiconductor device including a transistor arranged in a charge/discharge path of a secondary battery and a control integrated circuit (IC) configured to control the transistor based on a signal received at a signal terminal, it is necessary to protect the control IC from ESD on the signal terminal. However, no specific method for protecting the control IC from ESD has been proposed.

In a semiconductor device on which an integrated circuit configured to control charging and discharging of a secondary battery is mounted, the integrated circuit can be protected from an abnormally high voltage applied to an external terminal.

Embodiments will be described with reference to the drawings below. Hereinafter, the reference numerals the same as the signal names may be used for signal lines, signal terminals, and signal nodes through which signals are transmitted. The reference numerals the same as the voltage names may be used for voltage lines, voltage terminals, and voltage nodes through which voltages are supplied. In each of the drawings, the same reference numerals are used for the same components, and duplicated descriptions may be omitted.

### (Example of Semiconductor Device of Embodiment)

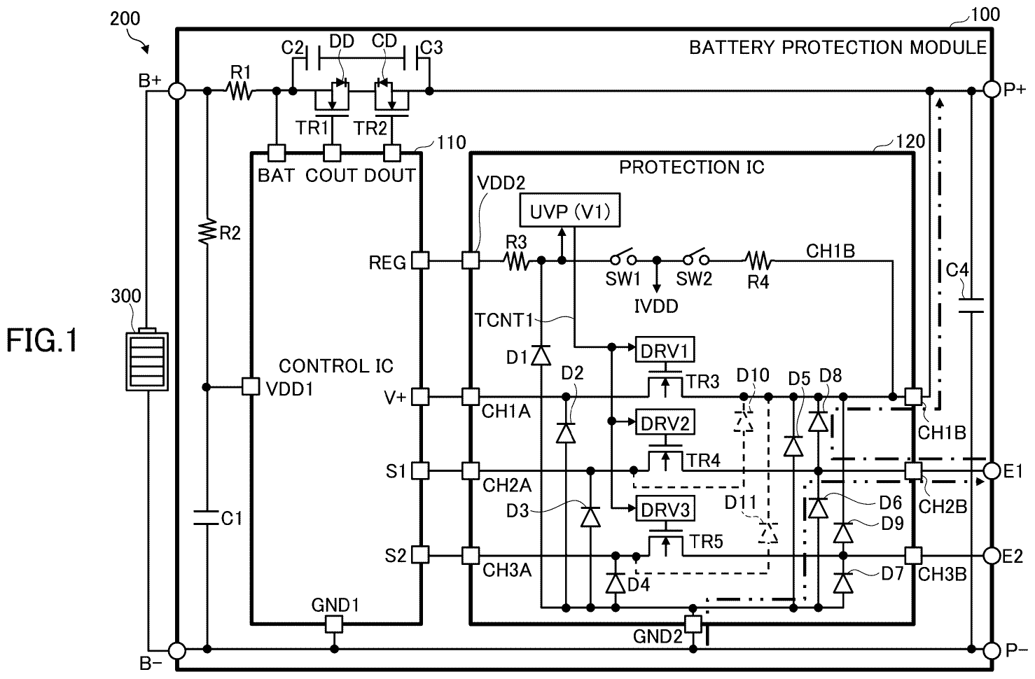

FIG. 1 is a block diagram illustrating an embodiment of a semiconductor device according to the present disclosure. For example, a battery protection module 100 illustrated in FIG. 1 is mounted on a battery pack 200 together with a secondary battery 300 such as a Li-ion battery. The battery protection module 100 includes a control integrated circuit (IC) 110, a protection IC 120, transistors TR1 and TR2, resistors R1 and R2, and capacitors C1, C2, C3, and C4.

In FIG. 1, external terminals of the battery protection module 100 are indicated by circles, and internal terminals of the battery protection module 100 are indicated by squares. For example, the external terminals of the battery protection module 100 are terminals provided on a connector for connecting the secondary battery 300 and a connector for connecting an electronic device or a charger. The internal terminals are also external terminals of the control IC 110 and the protection IC 120. The battery protection module 100 is an example of a semiconductor device. The protection IC 120 is an example of a first integrated circuit, and the control IC 110 is an example of a second integrated circuit.

The battery protection module 100 includes external terminals B+, B−, P+, P−, E1, and E2. The external terminals B+, B−, and P+ are examples of a first external terminal, a second external terminal, and a third external terminal, respectively. The external terminal E1 is an example of a fourth external terminal configured to receive a signal from the outside or output a signal to the outside. The external terminal B+ is connected to the positive electrode of the secondary battery 300, and the external terminal B− is connected to the negative electrode of the secondary battery 300.

The external terminals P+ and P− are respectively connected to a power supply terminal and a ground terminal of an electronic device, which is not illustrated. The external terminals P+ and P− may be respectively connected to a power supply terminal and a ground terminal of a charger, which is not illustrated. Here, the charger may be connected to the battery pack 200 via the electronic device. The external terminal P+ outputs a high voltage present at the positive electrode of the secondary battery 300 to the outside. The external terminal P− outputs a low voltage present at the negative electrode of the secondary battery 300 to the outside. Although not particularly limited, for example, the secondary battery 300 outputs a maximum of 4.2 V when fully charged.

For example, the electronic device connected to the battery pack 200 is a portable device, such as a mobile phone, a smartphone, a tablet, or an earphone. Here, the electronic device is not limited to a portable device as long as a device to which the battery pack 200 is connected can be operated by the electric power of the secondary battery 300.

The resistor R1 and the transistors TR1 and TR2 are connected in series between the external terminal B+ and the external terminal P+. The resistor R2 and the capacitor C1 are connected in series between the external terminal B+ and the external terminal B−. The external terminal B− is connected to the external terminal P−. The capacitors C2 and C3 are connected in series between the source of the transistor TR1 and the source of the transistor TR2. The capacitor C4 is connected between the external terminal P+ and the external terminal P−.

The control IC 110 includes power supply terminals VDD1 and REG, a ground terminal GND1, a terminal BAT, a charge control terminal COUT, a discharge control terminal DOUT, and terminals V+, S1, and S2. The protection IC 120 includes a power supply terminal VDD2, a ground terminal GND2, and terminals CHIA, CH2A, CH3A, CH1B, CH2B, and CH3B. The power supply terminals VDD1 and REG and the terminal V+ are examples of a third power supply terminal, a fourth power supply terminal, and a third voltage terminal, respectively. The terminals S1 and S2 are examples of a third signal terminal configured to receive or output a signal. The power supply terminal VDD2 and the ground terminal GND2 are examples of a first power supply terminal and a second power supply terminal, respectively. The terminals CHIA, CH2A, CH1B, and CH2B are examples of a second voltage terminal, a second signal terminal, a first voltage terminal, and a first signal terminal, respectively.

Additionally, the protection IC 120 includes a low-voltage protection circuit UVP (under voltage protect), resistors R3 and R4, switches SW1 and SW2, drivers DRV1, DRV2, and DRV3, and transistors TR3, TR4, and TR5. Further, the protection IC 120 includes diodes D1, D2, D3, D4, D5, D6, D7, D8, and D9. The diodes D6 and D7 are examples of a third diode. The diodes D8 and D9 are examples of a first diode. The transistors TR3 and TR4 are examples of a second switch and a first switch, respectively.

In the control IC 110, the power supply terminal VDD1 is connected to the external terminal B+ via the resistor R2, and is connected to the external terminal B− via the capacitor C1. That is, the resistor R2 and the capacitor C1 are connected in series between the external terminals B+ and B− via a connection node of the power supply terminal VDD1. The ground terminal GND1 is connected to the external terminals B− and P−. The power supply terminal REG is connected to the power supply terminal VDD2 of the protection IC 120. The terminal BAT is connected to the external terminal B+ via the resistor R1. The charge control terminal COUT is connected to the gate of the transistor TR1, and the discharge control terminal DOUT is connected to the gate of the transistor TR2. The terminal V+ is connected to the terminal CHIA of the protection IC 120. The terminal S1 is connected to the terminal CH2A of the protection IC 120, and the terminal S2 is connected to the terminal CH3A of the protection IC 120.

The transistors TR1 and TR2 are, for example, N-channel metal oxide semiconductor field effect transistors (MOSFETs) and function as switches. The transistor TR1 includes a parasitic diode DD, and the transistor TR2 includes a parasitic diode CD. The parasitic diode DD has an anode connected to the source of the transistor TR1 and a cathode connected to the drain of the transistor TR1. The parasitic diode CD has an anode connected to the source of the transistor TR2 and a cathode connected to the drain of the transistor TR2.

The control IC 110 outputs, to the gate of the transistor TR1, a charge control signal COUT for controlling the conduction and cutoff between the source and drain of the transistor TR1. The transistor TR1 is in a conductive state while receiving the high level of the charge control signal COUT and is in a cutoff state while receiving the low level of the charge control signal COUT. Additionally, the control IC 110 outputs, to the gate of the transistor TR2, a discharge control signal DOUT for controlling the conduction and cutoff of the transistor TR2. The transistor TR2 is in a conductive state while receiving the high level of the discharge control signal DOUT and is in a cutoff state while receiving the low level of the discharge control signal DOUT. Hereinafter, the conduction and cutoff between the source and drain of the transistor are referred to as ON and OFF, respectively.

While the transistor TR1 is ON and the transistor TR2 is OFF, the parasitic diode CD forms a charge path from the external terminal P+ to the positive electrode of the secondary battery 300. While the transistor TR1 is OFF and the transistor TR2 is ON, the parasitic diode CD forms a discharge path from the positive electrode to the external terminal P+ of the secondary battery 300.

When the secondary battery 300 is charged, the control IC 110 monitors the voltage of the external terminal P+ received at the terminal V+, and in response to detecting that the voltage of the external terminal P+ is higher than the overcharge detection voltage, the transistor TR1 is turned off to protect the secondary battery 300 from a charging abnormality such as overcharge. That is, when the voltage of the external terminal P+ is supplied to the terminal V+ of the control IC 110 via the protection IC 120, the control IC 110 can detect the overvoltage of the external terminal P+ and turn off the transistor TR1, thereby protecting the secondary battery 300 from overvoltage.

When the secondary battery 300 is discharged, the control IC 110 monitors the voltage received at the terminal BAT, and in response to detecting that the voltage is lower than the over-discharge detection voltage, the transistor TR2 is turned off to protect the secondary battery 300 from a discharging abnormality such as over-discharge.

The control IC 110 operates by receiving the power supply voltage and the ground voltage from the secondary battery 300 at the power supply terminal VDD1 and the ground terminal GND1. Additionally, the control IC 110 generates the power supply voltage VDD2 from the power supply voltage VDD1 by a built-in regulator (not illustrated), for example, and supplies the generated power supply voltage VDD2 to the power supply terminal VDD2 of the protection IC 120 via the power supply terminal REG. For example, the value of the power supply voltage VDD2 may be equal to the value of the power supply voltage VDD1, or may be lower than the value of the power supply voltage VDD1. When the power supply voltage VDD1 becomes lower than a predetermined value, the power supply voltage VDD2 falls following the fall of the power supply voltage VDD1.

The terminals S1 and S2 are electrically connected to the external terminals E1 and E2, respectively, via the protection IC 120. For example, the external terminals E1 and E2 receive sensor data detected by various sensors mounted on the electronic device in a state in which the electronic device is connected to the battery protection module 100. For example, the various sensors are a temperature sensor configured to detect the temperature of the electronic device, a pressure sensor configured to detect the expansion of the electronic device, and the like. When the sensor data received at the terminals S1 and S2 indicates an abnormality, the control IC 110 turns off the transistors TR1 and TR2 to stop charging and discharging the secondary battery 300. For example, the sensor data is transmitted using an I²C interface, in which the terminal S1 is a clock terminal and the terminal S2 is a data terminal.

Here, the control IC 110 may detect the state of the secondary battery 300 (a remaining capacity or a full charge state) based on the voltage received at the terminal BAT when the secondary battery 300 is discharged or charged. Then, the control IC 110 transmits the detected state to the charger via the terminals S1 and S2, the protection IC 120, and the external terminals E1 and E2. The charger, having received the state of the secondary battery 300, transmits a charging instruction or a charging stop instruction for the secondary battery 300 to the terminals S1 and S2 of the control IC 110 via the external terminals E1 and E2 and the protection IC 120. The control IC 110 controls the transistors TR1 and TR2 in accordance with the received instruction, and starts charging the secondary battery 300 or stops charging the secondary battery 300.

The protection IC 120 operates by the power supply voltage VDD2 supplied from the control IC 110 or the voltage received at the terminal CH1B, and the ground voltage received at the ground terminal GND2. In the protection IC 120, the terminal CHIA is connected to the terminal V+ of the control IC 110, the terminal CH2A is connected to the terminal S1 of the control IC 110, and the terminal CH3A is connected to the terminal S2 of the control IC 110. The terminal CH1B is connected to the external terminal P+, the terminal CH2B is connected to the external terminal E1, and the terminal CH3B is connected to the external terminal E2. The ground terminal GND2 is connected to the external terminals P− and B−. The capacitor C4 is connected between the external terminals P+ and P−.

The diode D1 has an anode connected to the ground terminal GND2 and a cathode connected to the power supply terminal VDD2 via the resistor R3. The diode D2 has an anode connected to the ground terminal GND2 and a cathode connected to the terminal CHIA. The diode D3 has an anode connected to the ground terminal GND2 and a cathode connected to the terminal CH2A. The diode D4 has an anode connected to the ground terminal GND2 and a cathode connected to the terminal CH3A.

The diode D5 has an anode connected to the ground terminal GND2 and a cathode connected to the terminal CH1B. The diode D6 has an anode connected to the ground terminal GND2 and a cathode connected to the terminal CH2B. The diode D7 has an anode connected to the ground terminal GND2 and a cathode connected to the terminal CH3B. The diode D8 has an anode connected to the terminal CH2B and a cathode connected to the terminal CH1B (that is, the external terminal P+). The diode D9 has an anode connected to the terminal CH3B and a cathode connected to the terminal CH1B (that is, the external terminal P+).

As illustrated by a broken line, the protection IC 120 may include a diode D10 having an anode connected to the terminal CH2A and a cathode connected to the terminal CHIB. As illustrated by a broken line, the protection IC 120 may include a diode D11 having an anode connected to the terminal CH3A and a cathode connected to the terminal CH1B. The diodes D10 and D11 are examples of a second diode.

Here, when the control IC 110 can be protected from ESD on the external terminal of the battery protection module 100 by the diodes D5, D6, D7, D8, and D9, one or more diodes among the diodes D1, D2, D3, D4, D10, and D11 need not be arranged in the protection IC 120.

For example, the transistors TR3, TR4, and TR5 are N-channel MOSFETs and function as switches. The transistor TR3 is arranged between the terminals CH1A and CH1B and operates by receiving a control signal from the driver DRV1 at its gate. The transistor TR4 is arranged between the terminals CH2A and CH2B and operates by receiving a control signal from the driver DRV2 at its gate. The transistor TR5 is arranged between the terminals CH3A and CH3B and operates by receiving a control signal from the driver DRV3 at its gate.

For example, the switches SW1 and SW2 may be transistors such as MOSFETs. The switches SW1 and SW2 are exclusively turned on by a switch control circuit, which is not illustrated, and supply the power supply voltage VDD2 or the voltage at the terminal CH1B to an internal power supply line IVDD in the protection IC 120 as an internal power supply voltage IVDD. The internal power supply voltage IVDD is supplied to an internal circuit of the protection IC 120. As described, the power supply voltage VDD2 and the voltage at the terminal CHIB are used as the operating power supply of the protection IC 120. Here, the protection IC 120 may include a regulator configured to convert the voltages of the power supply line VDD2 and the terminal CHIB respectively received through the switches SW1 and SW2 into the internal power supply voltage IVDD.

Operating the switches SW1 and SW2 exclusively can suppress through-current between the terminal CH1B and the power supply terminal VDD2 caused by simultaneously turning on the switches SW1 and SW2. As a result, damage to the control IC 110 or the protection IC 120 due to through-current can be suppressed.

Here, even when the switches SW1 and SW2 are temporarily turned on simultaneously, through-current flowing between the power supply line VDD2 and the terminal CHIB can be mitigated by the resistor R3 arranged between the power supply terminal VDD2 and the switch SW1 and the resistor R4 arranged between the terminal CHIB and the switch SW2. As a result, when the switches SW1 and SW2 are exclusively switched on (conduction) and off (cutoff) by a single control signal, it is possible to allow the switches SW1 and SW2 to be temporarily turned on simultaneously at the time of switching the switches SW1 and SW2. Therefore, the configuration of the circuit configured to control the switching of the switches SW1 and SW2 can be simplified, and the power consumption of the protection IC 120 can be reduced. As a result, the cost and the power consumption of the battery protection module 100 can be reduced.

For example, the protection IC 120 performs the control such that the voltage received at the terminal CH1B is supplied to the internal power supply line IVDD with priority over the power supply voltage VDD2 received at the power supply terminal VDD2. When the charger is connected to the battery protection module 100, the transistor TR1 is turned on, and the secondary battery 300 is charged, the protection IC 120 turns on only the switch SW2. Additionally, when the charger is removed from the battery protection module 100, the transistor TR2 is turned on, and the secondary battery 300 is discharged, the protection IC 120 turns on only the switch SW2.

When the charger is removed from the battery protection module 100, the discharge voltage of the secondary battery 300 is lower than a predetermined voltage, and the transistors TR1 and TR2 are turned off, the external terminal P+ and the terminal CH1B are in a floating state. In this case, the protection IC 120 turns on only the switch SW1.

As described, when a voltage is supplied to the terminal CH1B, the protection IC 120 turns on only the switch SW2, and when no voltage is supplied to the terminal CH1B, the protection IC 120 turns on only the switch SW1. Here, the battery protection module 100 can detect whether a charger or an electronic device is connected to the battery protection module 100 by monitoring the voltage of the external terminal P−.

When the power supply voltage VDD2 received via the resistor R3 becomes lower than a preset voltage V1, the low-voltage protection circuit UVP outputs, to the drivers DRV1, DRV2, and DRV3, respective control signals TCNT1 for turning off the transistors TR3, TR4, and TR5. The voltage V1 is an example of a first voltage. Although not particularly limited, the voltage V1 may be, for example, 1.7 V.

For example, when the power supply voltage VDD2 is lower than the voltage V1, the power supply voltage VDD1 supplied to the control IC 110 and used for generating the power supply voltage VDD2 is a voltage at which it is difficult for the control IC 110 to operate normally. That is, when the power supply voltage VDD2 is lower than the voltage V1, there is a possibility that the control IC 110 cannot correctly receive the logic of the signal supplied to the terminals S1 and S2, and cannot transmit the signal with the correct logic from the terminals S1 and S2.

When the power supply voltage VDD1 is low and the control IC 110 cannot correctly receive the logic of the signal supplied to the terminals S1 and S2, by turning off the transistors TR4 and TR5, malfunction of the protection IC 120 can be suppressed. Additionally, when the power supply voltage VDD1 is low and the control IC 110 cannot transmit the signal of the correct logic from the terminals S1 and S2, by turning off the transistors TR4 and TR5, transmission of the signal from the terminals S1 and S2 to the outside can be stopped, and malfunction of the electronic device or the charger receiving the signal transmitted from the control IC 110 can be suppressed.

When the power supply voltage VDD2 is higher than or equal to the voltage V1, the low-voltage protection circuit UVP outputs, to the drivers DRV1, DRV2, and DRV3, control signals TCNT1 for turning on the transistors TR3, TR4, and TR5, respectively. When the power supply voltage VDD2 becomes higher than or equal to the voltage V1 and it is detected that the power supply voltage VDD1 has returned to a normal value, by turning on the transistors TR4 and TR5, the control IC 110 can resume reception of the signal supplied to the terminals S1 and S2, and can resume transmission of the signal from the terminals S1 and S2.

When no charger is connected to the battery protection module 100, the control IC 110 operates while receiving the power supply voltage VDD1 that is higher than or equal to a predetermined value from the secondary battery 300, generates the power supply voltage VDD2, and outputs it to the power supply terminal REG. The protection IC 120 operates by receiving the power supply voltage VDD2 from the power supply terminal REG. That is, the battery protection module 100 operates by receiving the power from the secondary battery 300 even when no charger is connected to the battery protection module 100.

When the battery protection module 100 is operating and the power supply voltage VDD1 is higher than or equal to the voltage V1, the transistors TR3, TR4, and TR5 are turned on and the external terminals P+, E1, and E2 are electrically connected to the terminals V+, S1, and S2 of the control IC 110, respectively. In this state, when a charged electronic device or a charged charger is connected to the battery protection module 100, or when a charged user's finger or the like touches the external terminals E1 and E2, positive ESD may occur on one or both of the terminals CH2B and CH3B of the protection IC 120 with respect to the ground terminal GND2.

When positive ESD occurs on the terminal CH2B, as illustrated by a dash-dot line in FIG. 1, a discharge current due to ESD can be caused to flow to the external terminal P+ via the diode D8 and the terminal CH1B. Similarly, when positive ESD occurs on the terminal CH3B, a discharge current can be caused to flow to the external terminal P+ via the diode D9 and the terminal CH1B. Additionally, a part of the discharge current can be stored in the capacitors C3 and C4 as electric charges. With this, the discharge current due to ESD can be prevented from flowing to the terminals S1 and S2 of the control IC 110, and the control IC 110 can be prevented from being damaged.

Furthermore, when the protection IC 120 includes the diode D10, the discharge current flowing to the terminal CH2B due to positive ESD can be caused to flow to the external terminal P+ via the transistor TR4, the diode D10, and the terminal CH1B, in addition to the path via the diode D8. Similarly, when the protection IC 120 includes the diode D11, the discharge current flowing to the terminal CH3B due to positive ESD can be caused to flow to the external terminal P+ via the transistor TR5, the diode D11, and the terminal CH1B, in addition to the path via the diode D9. With this, the ESD resistance to the terminals S1 and S2 of the control IC 110 can be further improved in comparison with the case where the diodes D10 and D11 are not mounted on the protection IC 120.

Here, when negative ESD occurs on the terminal CH2B of the protection IC 120 with respect to the ground terminal GND2 in a state where the battery protection module 100 is operating, as illustrated by a dash-dot-dot line in FIG. 1, a discharge current can be caused to flow from the ground terminal GND2 to the terminal CH2B via the diode D6 and then to the external terminal E1. Similarly, when negative ESD occurs on the terminal CH3B of the protection IC 120 with respect to the ground terminal GND2 in a state where the battery protection module 100 is operating, a discharge current can be caused to flow from the ground terminal GND2 to the terminal CH3B via the diode D7 and then to the external terminal E1.

Here, when an abnormally high voltage or an abnormally negative voltage such as ESD is not applied to the battery protection module 100, the high-level voltage of the signal input to or output from the terminals CH2B and CH3B is lower than the voltage at the terminal CH1B. Therefore, a reverse voltage is applied to the diodes D8 and D9, and through-current can be prevented from flowing from the terminals CH2B and CH3B to the terminal CHIB via the diodes D8 and D9.

### (Example of Another Semiconductor Device)

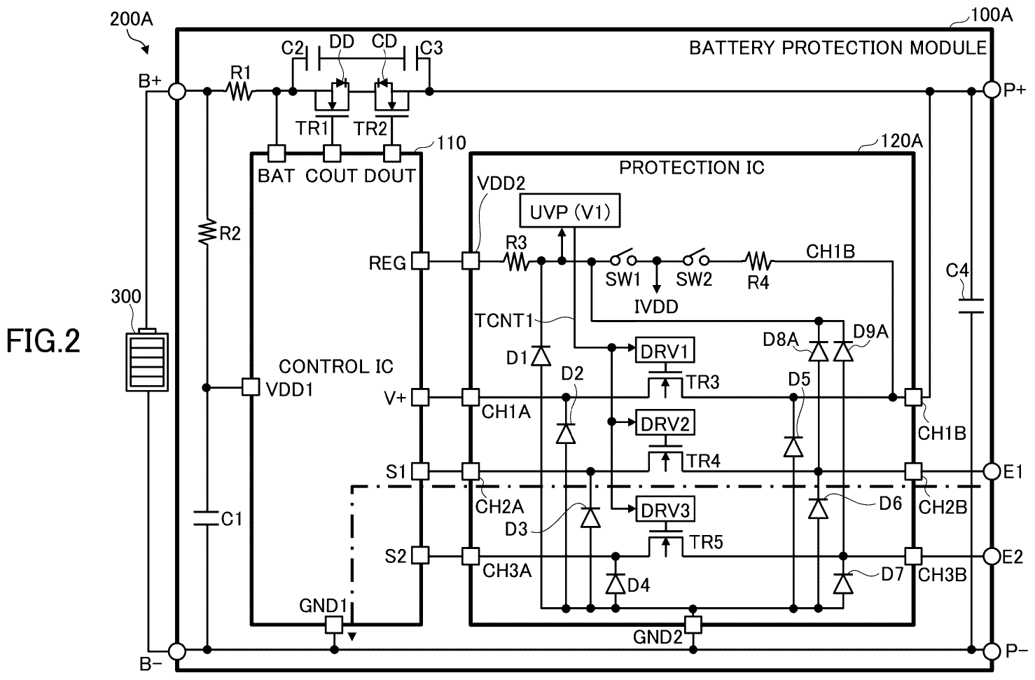

FIG. 2 is a block diagram illustrating an example of another semiconductor device. Elements substantially the same as those in FIG. 1 are denoted by the same reference numerals, and detailed description thereof is omitted. For example, a battery protection module 100A illustrated in FIG. 2 is mounted on a battery pack 200A together with the secondary battery 300. The battery protection module 100A is an example of the semiconductor device. The battery protection module 100A has a configuration substantially the same as the battery protection module 100 illustrated in FIG. 1 except that a protection IC 120A is included instead of the protection IC 120 illustrated in FIG. 1. Here, the battery protection module 100A illustrated in FIG. 2 corresponds to a comparative example of the present disclosure. The protection IC 120A has a configuration substantially the same as the protection IC 120 illustrated in FIG. 1 except that diodes D8A and D9A are included instead of the diodes D8, D9, D10, and D11 illustrated in FIG. 1.

When the diode D8 illustrated in FIG. 1 is not mounted on the protection IC 120A, the discharge current due to ESD flows from the external terminal E1 to the ground terminal GND2 of the protection IC 120A via the diode D6 when the voltage due to positive ESD on the external terminal E1 becomes higher than or equal to the breakdown voltage of the diode D6.

However, until the voltage due to positive ESD on the external terminal E1 becomes higher than or equal to the breakdown voltage of the diode D6, as illustrated by a dash-dot line, the discharge current due to ESD flows from the external terminal E1 to the ground terminal GND1 of the control IC 110 via the protection IC 120A and the terminal S1 of the control IC 110. Similarly, until the voltage due to positive ESD on the external terminal E2 becomes higher than or equal to the breakdown voltage of the diode D7, when the diode D9 illustrated in FIG. 1 is not mounted on the protection IC 120A, the discharge current due to ESD flows from the external terminal E2 to the ground terminal GND1 of the control IC 110 via the protection IC 120A and the terminal S2 of the control IC 110.

For example, the rated voltage of the control IC 110 is lower than the breakdown voltage of the diodes D6 and D7. Thus, when the diodes D8A and D9A and the diodes D8 and D9 illustrated in FIG. 1 are not mounted on the protection IC 120A, the control IC 110 may be damaged when a positive voltage due to the discharge current is applied to the terminals S1 and S2 until the diodes D6 and D7 break down. In other words, by mounting the diodes D8 and D9 on the protection IC 120 illustrated in FIG. 1, the control IC 110 can be prevented from being damaged even when ESD on the external terminals E1 and E2 occurs.

Additionally, when, instead of the diode D8 illustrated in FIG. 1, the diode D8A having the anode connected to the terminal CH2B and the cathode connected to the power supply terminal VDD2 via the resistor R3 is arranged as illustrated in FIG. 2, the following problems occur. When a positive ESD on the external terminal E1 occurs, the discharge current flows to the power supply terminal REG of the control IC 110 via the diode D8A, the resistor R3, and the power supply terminal VDD2. Here, when the rated voltage of the power supply terminal REG of the control IC is low and the protection against ESD is insufficient, the control IC 110 may be damaged.

With respect to the above, as illustrated in FIG. 1, if the discharge current due to positive ESD on the external terminal E1 can be caused to flow to the terminal P+ via the diode D8 and the terminal CH1B, the control IC 110 is not damaged because the discharge current flows to the power supply line that mutually connects the terminal B+ and the terminal P+ connected to the positive electrode of the secondary battery 300. Here, when, instead of the diode D9 illustrated in FIG. 1, the diode D9A having the anode connected to the terminal CH3B and the cathode connected to the power supply terminal VDD2 via the resistor R3 is arranged as illustrated in FIG. 2, the control IC 110 may be damaged when the positive ESD on the external terminal E2 occurs, as described above.

As described above, in the embodiment illustrated in FIG. 1, when ESD occurs on the terminals CH2B and CH3B, the discharge current due to positive ESD can be caused to flow to the external terminal P+ via the diodes D8 and D9. With this, the discharge current due to ESD can be prevented from flowing to the terminals S1 and S2 of the control IC 110, and the control IC 110 can be prevented from being damaged.

When the protection IC 120A includes the diodes D10 and D11, the discharge current flowing to the terminals CH2B and CH3B due to ESD can be caused to flow to the external terminal P+ via the diodes D10 and D11 in addition to the path of the diodes D8 and D9. With this, in comparison with the case where the diodes D10 and D11 are not mounted on the protection IC 120A, the ESD resistance to the terminals S1 and S2 of the control IC 110 can be further improved.

When negative ESD occurs on the terminals CH2B and CH3B of the protection IC 120A with respect to the ground terminal GND2 while the battery protection module 100 is operating, the discharge current can be caused to flow from the ground terminal GND2 to the external terminals E1 and E2 via the diodes D6 and D7 and the terminals CH2B and CH3B. With this, the control IC 110 can be prevented from being damaged due to negative ESD on the external terminals E1 and E2.

Here, when an abnormally high voltage such as ESD is not applied to the battery protection module 100, the high-level voltage of the signal input to or output from the terminals CH2B and CH3B is lower than the voltage at the terminal CH1B. Therefore, a reverse voltage is applied to the diodes D8 and D9, and through-current can be prevented from flowing from the terminals CH2B and CH3B to the terminal CHIB via the diodes D8 and D9.

When the protection IC 120A detects, based on the fact that the power supply voltage VDD2 is lower than the voltage V1, that the power supply voltage VDD1 used by the control IC 110 to generate the power supply voltage VDD2 is also low, the transistors TR4 and TR5 are turned off. With this, when the power supply voltage VDD1 is low and the control IC 110 cannot correctly receive the logic of the signal supplied to the terminals S1 and S2, malfunction of the protection IC 120A can be prevented. Additionally, when the power supply voltage VDD1 is low and the control IC 110 cannot transmit a signal of correct logic from the terminals S1 and S2, transmission of the signal from the terminals S1 and S2 to the outside can be stopped, and malfunction of the electronic device or the charger that receives the signal transmitted from the control IC 110 can be prevented.

Additionally, when the protection IC 120A detects that the power supply voltage VDD2 has become higher than or equal to the voltage V1 from a state where the power supply voltage VDD2 is lower than the voltage V1 and the power supply voltage VDD1 has returned to a normal value, the transistors TR4 and TR5 are turned on. With this, the control IC 110 can resume reception of signals supplied to the terminals S1 and S2 and transmission of signals from the terminals S1 and S2.

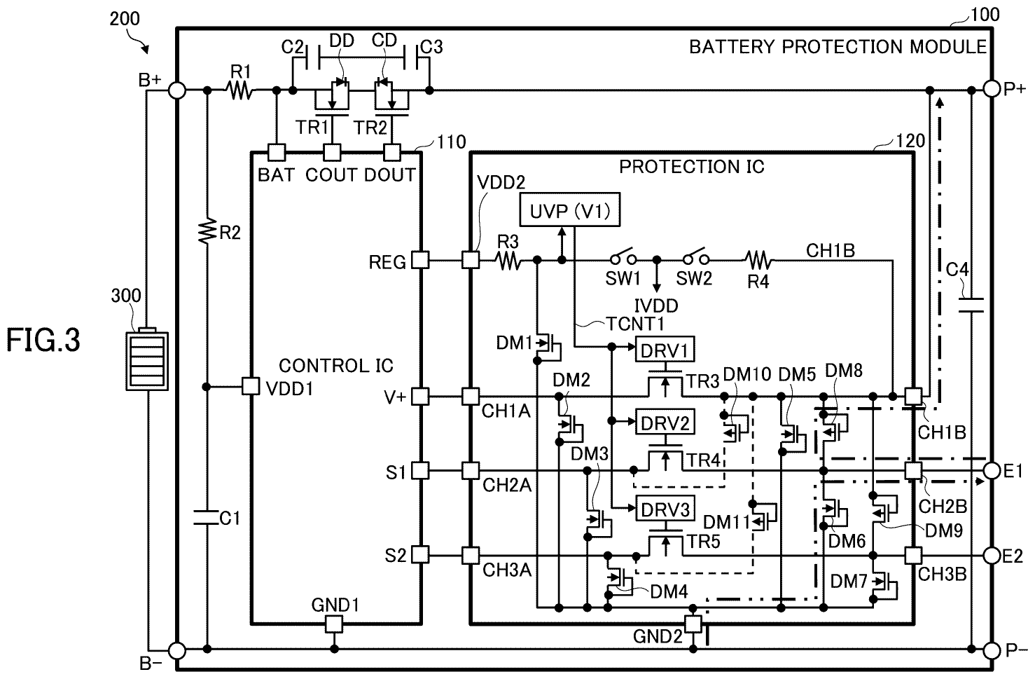

Additionally, the diodes D1 to D11 illustrated in FIG. 1 can be replaced with MOS transistors DM1 to DM11 functioning as ESD elements, each of which has a gate electrode connected to a source electrode as illustrated in FIG. 3. More specifically, the MOS transistor arranged between the power supply terminal VDD2 and the ground terminal GND2 is an N-type MOS transistor DM1, the drain electrode is connected to the power supply terminal VDD2, and the source electrode and the gate electrode are connected to the ground terminal GND2. The MOS transistor disposed between the terminal CHIA and the ground terminal GND2 is an N-type MOS transistor DM2, the drain electrode is connected to the terminal CHIA, and the source electrode and the gate electrode are connected to the ground terminal GND2. Similarly, N-type MOS transistors DM3 to DM7 are used as ESD elements connected to the ground terminal GND2, and the source electrode and the gate electrode are connected to the ground terminal GND2.

Additionally, when ESD does not occur, the source electrode and the gate electrode of each of the N-type MOS transistors DM1 to DM7 are at the voltage of the ground terminal GND2, and thus each of the N-type MOS transistors DM1 to DM7 is turned off, and the source electrode and the drain electrode are in a non-conductive state.

With respect to the above, the MOS transistor arranged between the terminal CH2B and the terminal CHIB is a P-type MOS transistor DM8, the source electrode and the gate electrode are connected to the terminal CHIB, and the drain electrode is connected to the terminal CH2B. The MOS transistor arranged between the terminal CH3B and the terminal CHIB is a P-type MOS transistor DM9, the source electrode and the gate electrode are connected to the terminal CH1B, and the drain electrode is connected to the terminal CH3B. The P− type MOS transistors DM8 and DM9 are examples of a first MOS transistor.

The MOS transistor arranged between the terminal CH2A and the terminal CHIB is a P-type MOS transistor DM10, the source electrode and the gate electrode are connected to the terminal CH1B, and the drain electrode is connected to the terminal CH2A. The MOS transistor arranged between the terminal CH3A and the terminal CHIB is a P-type MOS transistor DM11, the source electrode and the gate electrode are connected to the terminal CH1B, and the drain electrode is connected to the terminal CH3A. The P-type MOS transistors DM10 and DM11 are examples of a second MOS transistor.

For example, when positive ESD occurs on the terminal CH2B, the terminal CH3B, the terminal CH2A, or the terminal CH3A, the PN junction between the drain electrode and the back gate of the corresponding transistor among the P-type MOS transistors DM8, DM9, DM10, and DM11 becomes forward biased. As a result, ESD current flows from the drain electrode to the back gate.

With respect to the above, when negative ESD occurs on the terminal CH2B, the terminal CH3B, the terminal CH2A, or the terminal CH3A, the PN junction between the substrate and the drain electrode of the corresponding transistor among the N-type MOS transistors DM6, DM7, DM3, and DM4 become forward biased. As a result, an ESD current flows from the ground terminal GND2 to the drain electrode.

Additionally, when ESD does not occur on the terminal CH2B, the terminal CH3B, the terminal CH2A, or the terminal CH3A, the source electrode and the gate electrode of the corresponding transistor among the P-type MOS transistors DM8 to DM11 become the voltage at the terminal CH1B, that is, the voltage at the terminal P+, and thus the P-type MOS transistors DM8 to DM11 are turned off, and the source electrode and the drain electrode are in a non-conductive state.

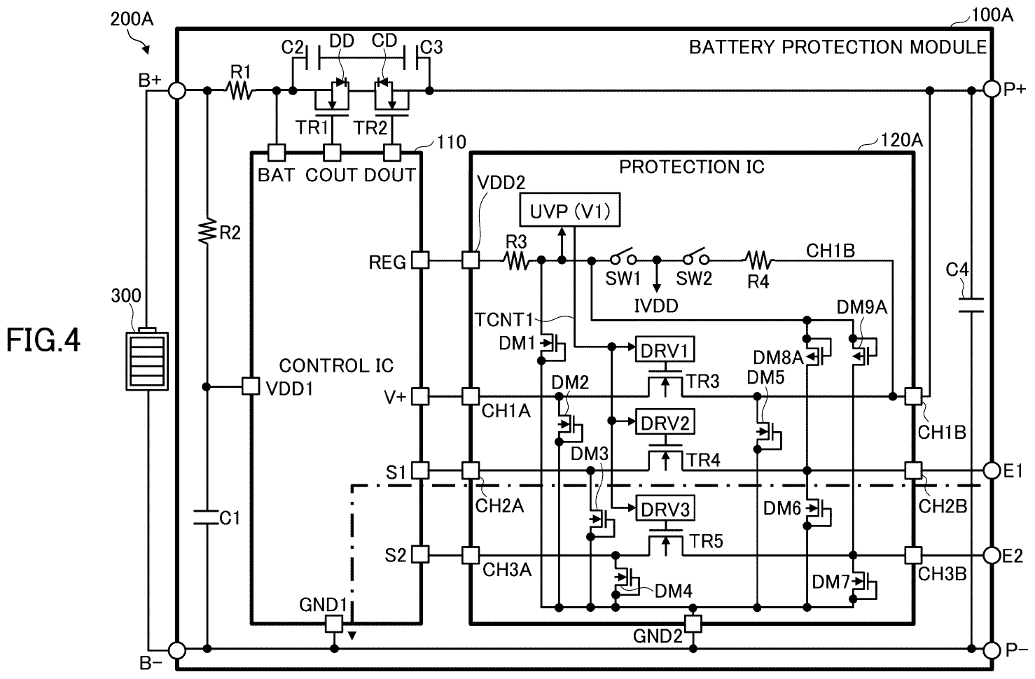

Similarly, the diodes D1 to D7 illustrated in FIG. 2 can be replaced with the N-type MOS transistors DM1 to DM7 as illustrated in FIG. 4. Additionally, the diodes D8A and D9A illustrated in FIG. 2 can be replaced with the P-type MOS transistors DM8A and DM9A as illustrated in FIG. 4.

Although the present invention has been described based on various embodiments, the present invention is not limited to the requirements illustrated in the above embodiments. These points can be changed to the extent that the object of the present invention is not lost, and can be appropriately defined according to the application mode.

What is claimed is:

1. A semiconductor device comprising:
a first external terminal connectable to a positive electrode of a secondary battery;
a second external terminal connectable to a negative electrode of the secondary battery;
a third external terminal electrically connected to the first external terminal and configured to output a voltage received from the secondary battery to an outside;
a fourth external terminal configured to receive a signal from the outside or output a signal to the outside;
a first integrated circuit including:
a first power supply terminal;
a first voltage terminal connected to the third external terminal;
a second power supply terminal connected to the second external terminal;
a first signal terminal connected to the fourth external terminal and configured to receive or output a signal;
a second signal terminal electrically connected to the first signal terminal; and
a first diode having an anode electrically connected to the first signal terminal and a cathode electrically connected to the first voltage terminal, and
a second integrated circuit including:
a third power supply terminal electrically connected to the first external terminal;
a fourth power supply terminal configured to output, to the first power supply terminal, a power supply voltage generated based on a voltage received at the third power supply terminal; and
a third signal terminal configured to receive a signal from the second signal terminal or output a signal to the second signal terminal, the second integrated circuit controlling charging and discharging of the secondary battery.

2. The semiconductor device as claimed in claim 1, wherein the first integrated circuit includes:
a first switch arranged between the first signal terminal and the second signal terminal; and
a second diode having an anode electrically connected to the second signal terminal and a cathode electrically connected to the first voltage terminal.

3. The semiconductor device as claimed in claim 1, wherein the first integrated circuit includes a third diode having an anode electrically connected to the second power supply terminal and a cathode electrically connected to the first signal terminal, and a rated voltage of the second integrated circuit is lower than a breakdown voltage of the third diode.

4. The semiconductor device as claimed in claim 1, wherein a high level voltage of the signal received or output by the first signal terminal is lower than a voltage supplied to the first voltage terminal.

5. The semiconductor device as claimed in claim 1,
wherein the first integrated circuit includes
a first switch arranged between the first signal terminal and the second signal terminal; and
a first control circuit configured to control the first switch, and
wherein the first control circuit turns off the first switch in response to detecting that a voltage received at the first power supply terminal becomes lower than a first voltage.

6. The semiconductor device as claimed in claim 5,
wherein the first integrated circuit includes:
a second voltage terminal;
a second switch arranged between the second voltage terminal and the first voltage terminal; and
a second control circuit configured to control the second switch,
wherein the second integrated circuit includes a third voltage terminal electrically connected to the second voltage terminal, and
wherein the second control circuit turns off the second switch in response to detecting that the voltage received at the first power supply terminal becomes lower than the first voltage.

7. The semiconductor device as claimed in claim 5, wherein the first control circuit turns on the first switch in response to detecting that the voltage received at the first power supply terminal becomes higher than or equal to the first voltage.

8. A semiconductor device comprising:
a first external terminal connectable to a positive electrode of a secondary battery;
a second external terminal connectable to a negative electrode of the secondary battery;
a third external terminal electrically connected to the first external terminal and configured to output a voltage received from the secondary battery to an outside;
a fourth external terminal configured to receive a signal from the outside or output a signal to the outside;
a first integrated circuit including:
a first power supply terminal;
a first voltage terminal connected to the third external terminal;
a second power supply terminal connected to the second external terminal;
a first signal terminal connected to the fourth external terminal and configured to receive or output a signal;
a second signal terminal electrically connected to the first signal terminal; and
a first metal oxide semiconductor (MOS) transistor having a drain electrically connected to the first signal terminal, and a source and a gate electrically connected to the first voltage terminal, and
a second integrated circuit including:
a third power supply terminal electrically connected to the first external terminal;
a fourth power supply terminal configured to output, to the first power supply terminal, a power supply voltage generated based on a voltage received at the third power supply terminal; and
a third signal terminal configured to receive a signal from the second signal terminal or output a signal to the second signal terminal, the second integrated circuit controlling charging and discharging of the secondary battery.

9. The semiconductor device as claimed in claim 8, wherein the first integrated circuit includes:
a first switch arranged between the first signal terminal and the second signal terminal; and
a second MOS transistor having a drain electrically connected to the second signal terminal, and a source and a gate electrically connected to the first voltage terminal.

10. The semiconductor device as claimed in claim 9, wherein the first MOS transistor and the second MOS transistor are P-type.
